(19) United States
(12) Patent Application Publication
(10) Pub. No.: US 2024/0176555 A1
(43) Pub. Date: May 30, 2024

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: Toshinori Kawaura, Kanagawa (JP)

(21) Appl. No.: 18/517,097

(22) Filed: Nov. 22, 2023

(30) Foreign Application Priority Data
Nov. 25, 2022 (JP) 2022-188295

(51) Int. Cl. G06F 3/12; H04W 12/06; H04W 76/11

(52) U.S. Cl. CPC G06F 3/1204; G06F 3/1231; G06F 3/1236; H04W 12/06; H04W 76/11; H04W 88/08

(57) ABSTRACT

An information processing apparatus includes: a first setup unit configured to execute first wireless setup in order to establish connection between a communication apparatus and an access point; and a display unit configured to display information for establishing the connection between the communication apparatus and the access point on a display unit of the information processing apparatus in a case where the connection between the communication apparatus and the access point is not established by the first setup unit.

### BACKGROUND

### Field

The present disclosure relates to an information processing apparatus, a method of controlling an information processing apparatus, and a storage medium storing a program.

### Description of the Related Art

There is a technique designed for sharing an instrument such as a printer on a network, on which two or more information processing apparatuses (hereinafter abbreviated as PCs) are present, by way of a local area network (LAN) connected to the Internet. Meanwhile, there is a case where the LAN is constructed in the form of a wireless network. In this case, there is an advantage over a wired network that instruments can be installed anywhere. However, there may be a case where a user faces a difficulty in setting up for causing an instrument such as a printer to participate in the wireless network.

Japanese Patent Laid-Open No. 2018-019279 discloses a technique designed to construct a direct connection environment between a PC and a printer by establishing wireless connection to a service set identifier (SSID) for direct connection of the printer for which a confirmation of usability of the PC has been made in advance.

### SUMMARY

There is a demand for a technique that enables easier setup for wireless connection.

An information processing apparatus according to an aspect of the present disclosure includes: a first setup unit configured to execute first wireless setup in order to establish connection between a communication apparatus and an access point; and a display unit configured to display information for establishing the connection between the communication apparatus and the access point on a display unit of the information processing apparatus in a case where the connection between the communication apparatus and the access point is not established by the first setup unit.

Further features of the present invention will become apparent from the following description of exemplary embodiments with reference to the attached drawings.

### BRIEF DESCRIPTION OF THE DRAWINGS

FIGS. 1A and 1B are diagrams for explaining system configurations;

FIG. 2 is a constitutional diagram of a PC and a printer;

FIG. 3 is a diagram showing the relationship of FIGS. 3A and 3B;

FIGS. 3A and 3B are flowcharts showing an example of processing to be executed by the PC and the printer;

FIG. 4 is a flowchart showing an example of processing to instruct wireless setup;

FIGS. 5A to 5G are diagrams showing display screens of the printer; and

FIGS. 6A to 6F are diagrams showing screens of an application to be displayed on the PC.

### DESCRIPTION OF THE EMBODIMENTS

A preferred embodiment of the present disclosure will be described below in detail with reference to the drawings. It is to be noted that the following embodiment is not intended to limit the scope of the present disclosure, and that the entire combination of features described in the present embodiment is not always essential for a solution of the present disclosure. In the following, a printer for printing images will be described as an example of a communication apparatus (an external apparatus) in the present embodiment. However, without limitation to the foregoing, processing in the present embodiment may be applied to various instruments including a PC, a smartphone, a digital camera, and the like. In the meantime, a PC will be described as an information processing apparatus in the present embodiment. However, without limitation to the foregoing, processing in the present embodiment may be applied to various instruments including a smartphone, a digital camera, and the like.

In the present embodiment, the information processing apparatus can execute network setup processing for a different apparatus. Here, the network setup for the different apparatus is processing to connect the different apparatus to an access point (AP) that forms a network. Specifically, the information processing apparatus transmits connection information on the access point to a communication apparatus through Wi-Fi connection between the information processing apparatus and the communication apparatus that operates as a wireless setup mode (a network setup mode) to be described later. For example, among APs connectable to the communication apparatus, the information processing apparatus automatically identifies an AP connected to the information processing apparatus, and transmits information concerning this AP to the communication apparatus. Then, the communication apparatus establishes the connection to the access point by using the connection information on the access point thus received. Hence, the communication apparatus can establish connection to the network formed by the access point. Although the communication method used for the network setup processing is assumed to be Wi-Fi communication, the communication method is not limited to this method. For example, the network setup may be executed in accordance with a communication method other than the Wi-Fi as typified by BLE and the like. Note that the information concerning the AP includes identification information (such as SSID) on the AP, and authentication information (such as a password) used in authentication processing of the AP.

Nevertheless, there is a case where the AP connected to the PC is distant from the printer and cannot be referred to or a case where the printer is not compatible with an encryption standard (such as WPA3) associated with the SSID of the AP connected to the PC. In such a case, the printer cannot establish the connection to the AP by using the information concerning the AP, which is transmitted from the PC. In this case, it is conceivable that a user performs network setup by operating a housing (such as an operating panel) of the printer. However, there is a timing at which the printer cannot accept such an operation. Examples of such a timing include a case where an arrival operation of a product is required, a case where copy processing is in progress, and so forth.

Given the circumstances, the present embodiment is configured to carry out network setup of a printer by operating the printer by way of a PC. In this way, the network setup of the printer can be carried out even at a timing that the printer cannot accept an operation. Now, the present embodiment will be described below in detail.

### First Embodiment

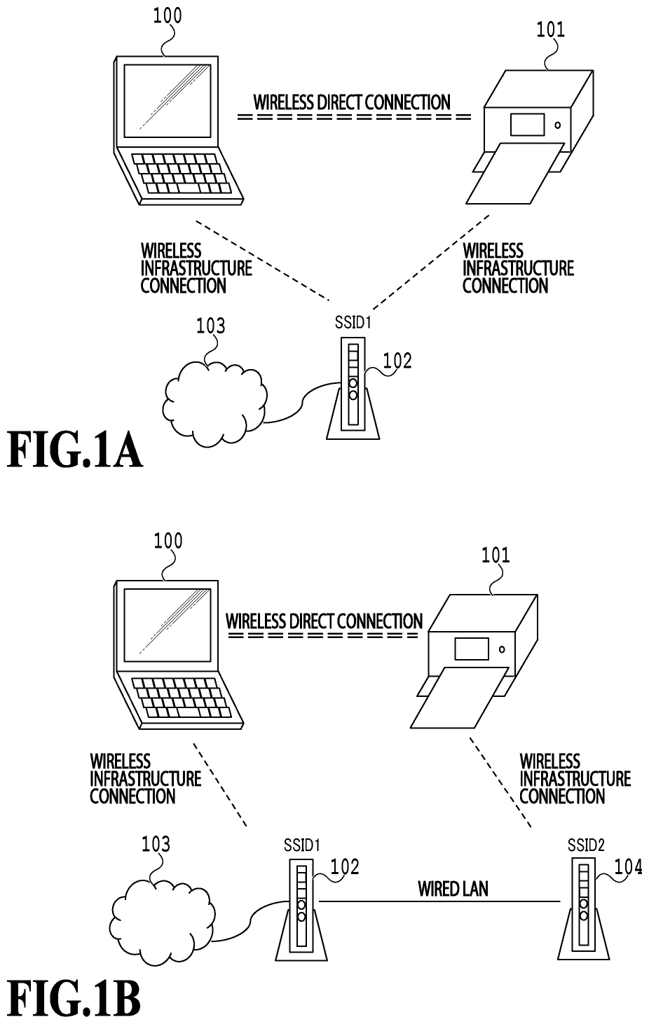

FIGS. 1A and 1B are diagrams for explaining system configurations in the present embodiment. A system of the present embodiment includes a PC, an instrument such as a printer, and one or more APs.

In FIG. 1A, a PC 100 is connected to SSID 1 of an AP 102 through a wireless LAN. Meanwhile, a printer 101 is also connected to the SSID 1 of the AP 102. In other words, the PC 100 is in a state of being capable of communicating with the printer 101 through the AP 102. As described above, a method of connection through an AP is referred to as infrastructure connection. In the infrastructure connection, it is possible to construct a network environment in which a PC can establish intercommunication with two or more devices. In the meantime, the AP 102 is connected to the Internet 103. In this way, the Internet 103 is accessible to the PC 100 and the printer 101 which are connected to the AP 102. In the present embodiment, a communication apparatus 151 operates as a slave station while an external access point operates as a master station in the infrastructure connection. In the present embodiment, the master station is an apparatus that determines a communication channel to be used in the network that the master station belongs to and the slave station is an apparatus that does not determine a communication channel to be used in the network that the slave station belongs to but uses the communication channel determined by the master station instead.

On the other hand, there is a communication method called wireless direct connection, which enables communication between two devices only without interposing an external apparatus that forms a network. In a case where the printer 101 operates in a P2P mode, which is a mode to cause the printer 101 to directly communicate with another apparatus such as an information processing apparatus without interposing an external apparatus that forms the network, the PC 100 and the printer 101 can establish P2P connection by means of the wireless direct connection. In the wireless direct connection, the printer 101 operates as the AP (the master station). The wireless communication is established by causing the PC 100 that serves as the slave station to carry out password authentication with the SSID issued by the printer 101 serving as the master station. Since the printer 101 operates as a simplified AP in the wireless direct connection, the printer 101 does not have a function to establish bridge connection to the AP 102. For this reason, the PC 100 and the printer 101 are unable to access the Internet 103 in the wireless direct connection. Here, the P2P mode may include a WFD mode for causing the communication apparatus 151 to communicate by way of Wi-Fi Direct (WFD), for example. Here, a determination as to which one of WFD-compatible instruments operates as the master station is made in accordance with a sequence called group owner negotiation, for example. Note that the master station may be determined without executing the group owner negotiation. In particular, an apparatus which is a WFD-compatible apparatus and plays a role as the master station will be referred to as a group owner. Direct connection to another apparatus to be established by the communication apparatus 151 that operates in the P2P mode will be referred to as direct connection. In the present embodiment, the communication apparatus 151 operates as the master station while the other apparatus functions as the slave station in the direct connection.

FIG. 1B shows an aspect in which the printer 101 establishes wireless infrastructure connection to SSID 2 of an AP 104. In the meantime, the AP 104 is bridge-connected to the AP 102. The above-described mode of connection enables connection to the Internet through the AP 104 in the case where the printer 101 is distant from the AP 102 and therefore has a difficulty in establishing the connection.

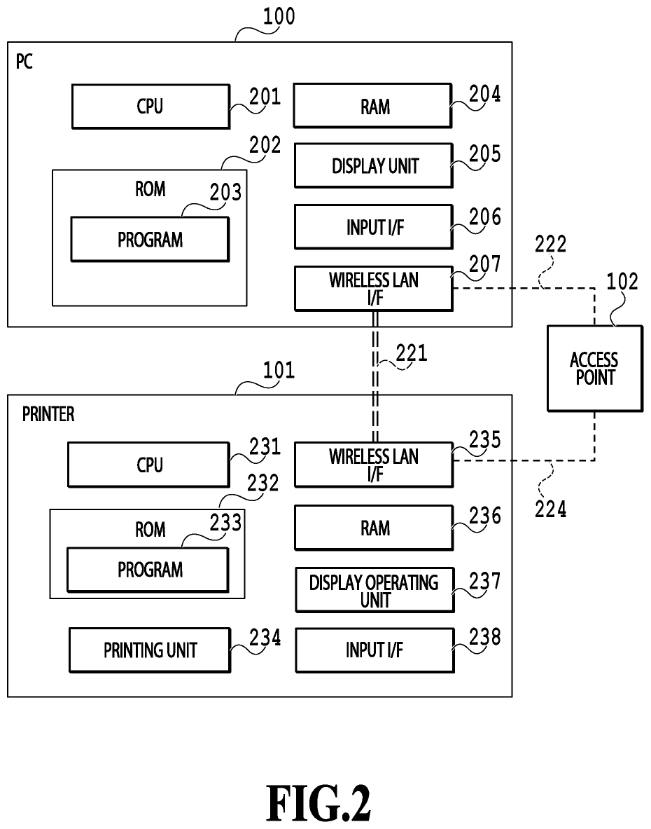

FIG. 2 is a constitutional diagram of a communication system including the PC 100 and the printer 101. The PC 100 includes a CPU 201, a ROM 202, a RAM 204, a display unit 205, an input interface (I/F) 206, and a wireless LAN I/F 207.

The ROM 202 stores programs 203 corresponding to a variety of processing including a program for wireless network setup processing for instructing the printer to carry out setup of a wireless network. Details of the aforementioned wireless network setup processing will be described later. The CPU 201 can execute the variety of processing including the above-mentioned instruction processing by loading the programs 203 from the ROM 202 to the RAM 204 and executes the programs.

The PC 100 can establish P2P communication with the printer 101 through direct connection 221 by using the wireless LAN I/F 207. Moreover, the PC 100 can also be connected to the AP 102 through wireless infrastructure connection 222. Likewise, the printer 101 can also be connected to the AP 102 through wireless infrastructure connection 224. As a consequence, the PC 100 and the printer 101 can communicate with each other.

The printer 101 includes a CPU 231, a ROM 232, a RAM 236, a display operating unit 237, an input I/F 238, a printing unit 234, and a wireless LAN I/F 235.

The ROM 232 stores a program 233. The CPU 231 loads the program 233 from the ROM 232 to the RAM 236 and executes program 233, thereby carrying out a variety of control by the printer 101.

The ROM 232 stores direct connection SSIDs to be issued as network identification information in a case where the printer 101 operates as the master station of the AP. The direct connection SSIDs include a constant connection SSID and a temporary connection SSID.

A unique name is allocated as the constant connection SSID to a product in a state of product shipment. However, it is also possible to change the name at a user's discretion. Meanwhile, the constant connection SSID is used in the case of establishing connection by carrying out the password authentication as with the ordinary AP and causing the PC to instruct the printer 101 to perform printing or scanning.

On the other hand, the temporary connection SSID is an SSID of which name cannot be changed from the name unique to the product. The temporary connection SSID is issued only the case where the printer 101 is in a state of network setup, and is capable of establishing the connection without requiring the password authentication (by open authentication). At the time of connection by using the temporary connection SSID, the connection can be established without the password. However, there are restrictions such as a restriction that allows the printer 101 to accept only specific operations as typified by an operation concerning the network setup. The printer 101 transitions to the state of network setup by causing the user to operate the input I/F 238 of the printer 101 or the display operating unit 237 thereof which is provided with a touch panel function. Hence, the printer 101 beacons the temporary connection SSID.

Meanwhile, in the case where the user powers on the printer 101 for the first time, the printer 101 activates an arrival mode. In the case where the printer 101 mounts the display operating unit (hereinafter referred to as an LCD) 237 that is large enough, the printer 101 displays operation guidance at the time of arrival such as guidance of an ink attaching method on the LCD in the arrival mode. Moreover, in the arrival mode, the printer 101 automatically transitions to the state of network setup without requiring a special operation by the user, and beacons the constant connection SSID.

FIG. 2 illustrates the example of assignment of the processing between the PC 100 and the printer 101 as described above. However, the present disclosure is not limited to the above-mentioned assignment of the processing and other modes of assignment are acceptable.

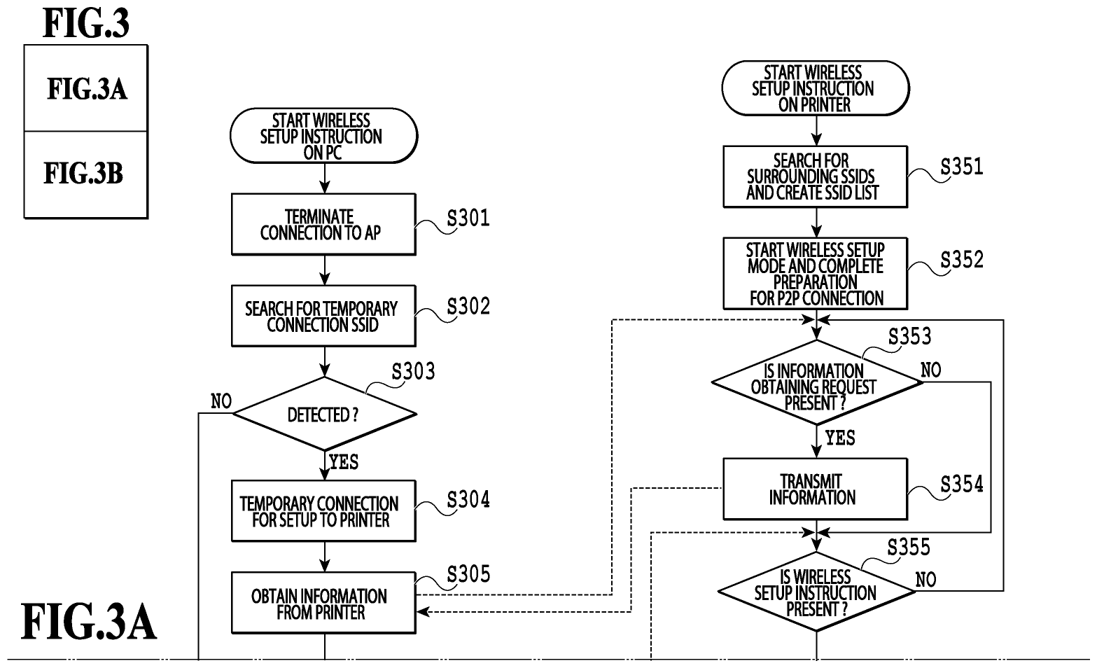

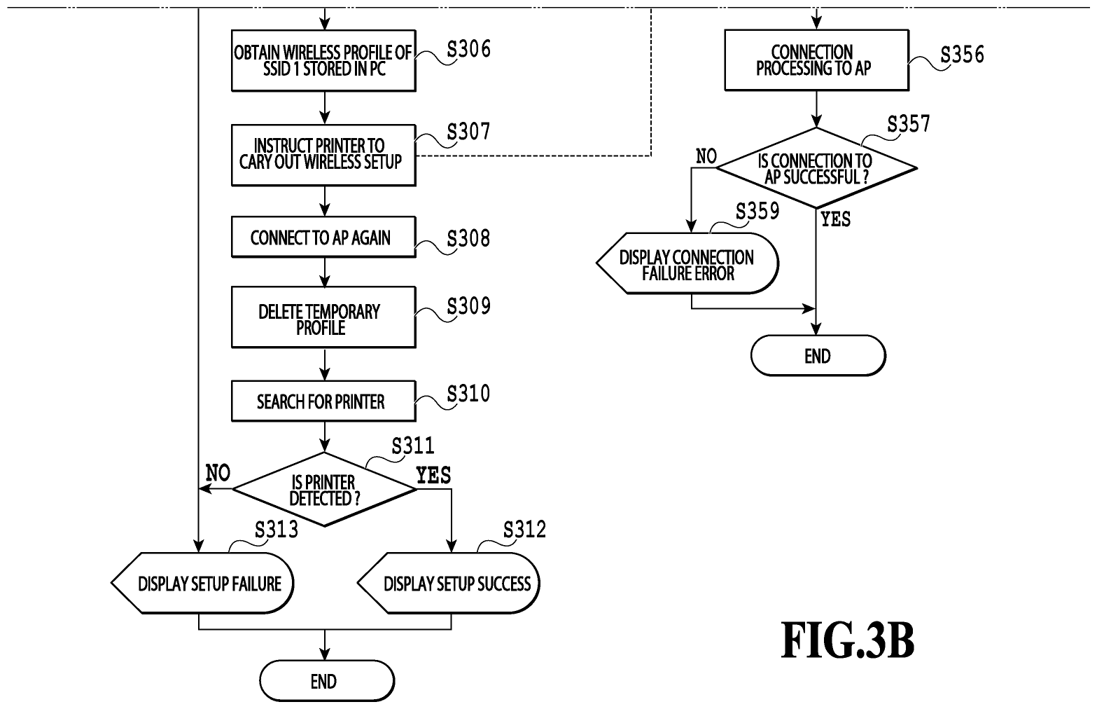

Wireless network setup processing to cause the PC 100 to connect the printer 101 to the prescribed AP 102 by way of the above-mentioned connection to the temporary connection SSID will be described in detail with reference to FIG. 3.

FIGS. 3A and 3B are flowcharts showing an example of processing to cause the printer to execute wireless setup instructed by the PC. The processing by the PC 100 is implemented by causing the CPU 201 to execute the programs 203. Likewise, the processing by the printer 101 is implemented by causing the CPU 231 to execute the program 233. There is a method of causing the PC 100 to instruct the wireless setup of the printer 101, and FIG. 3 explains a flow of processing of this method. Here, the PC 100 is assumed to have already been connected to the external AP 102, and authentication information such as the password for the SSID 1 of the AP 102 is assumed to be stored as a wireless profile in the ROM 202 in advance. The processing by the PC 100 and the printer 101 will be explained with reference to FIG. 3.

A description will be given of a wireless setup instruction (S301 to S313) to be executed by the PC 100 to begin with. A prescribed screen is displayed on the display unit 205 of the PC 100 in accordance with a program (such as an application) for the network setup processing included in the programs 203. The user carries out a predetermined instruction on the screen in order to connect the PC 100 to the printer. Thus, the PC 100 starts wireless setup instruction processing (processing to be carried out on the PC 100 side in the flowchart of FIG. 3).

First, in S301, the CPU 201 of the PC 100 terminates wireless connection to the AP 102 which is currently effective. In S302, the CPU 201 searches for the temporary connection SSID beaconed from the printer 101 in the state of network setup to be described later. In S303, the CPU 201 determines whether or not the SSID is successfully detected. To be more precise, the CPU 201 searches for the printer 101 in the state of network setup which behaves as the AP corresponding to the temporary connection SSID, and determines whether or not the search is successful. The CPU 201 proceeds to S304 in the case where the CPU 201 determines YES in S303. On the other hand, the CPU 201 proceeds to S313 in the case where the CPU 201 determines NO in S303.

In S304, the CPU 201 establishes temporary connection for network setup to the printer 101 which is in the state of network setup.

In S305, the CPU 201 issues an information obtaining request to the printer 101 and obtains a response from the printer 101, thus receiving a variety of information therefrom. The variety of information is an SSID list detected by the printer 101 by searching for the surrounding APs, or information including a MAC address of the wireless LAN I/F 235 included in the printer 101, and the like.

In S306, the CPU 201 refers to the wireless profile stored in the ROM 202, and obtains the authentication information such as the password associated with the SSID 1 of the AP 102. In this instance, the CPU 201 checks whether or not the SSID 1 of the AP 102 is included in the SSID list obtained in S305. It is understood that the SSID 1 of the AP 102 is visible from the printer 101 in the case where the SSID 1 of the AP 102 is included in the SSID list.

Next, in S307, the CPU 201 transmits information indicating an instruction to the printer 101 to carry out the wireless setup. To be more precise, the CPU 201 transmits the wireless profile (including the SSID 1 and the password) of the AP 102 to the printer 101. In S308, the CPU 201 terminates wireless direct connection for temporary connection to the printer 101, and establishes connection to the AP 102 again. Since the wireless profile of the AP 102 is saved in the ROM 202 in the PC 100, the PC 100 can establish the re-connection to the AP 102 in this processing without requiring the user to input the password and the like again.

In S309, the CPU 201 deletes the wireless profile of the wireless direct connection for temporary connection in the case where there is the wireless profile that temporarily remains in the wireless direct connection for temporary connection. This processing is carried out in order to avoid to leave behind a wireless profile of connection which is not intended by the user.

In S310, the CPU 201 searches for the printer 101 by way of the infrastructure connection through the AP 102. To be more precise, in S310, the PC 100 receives identification information (such as the MAC address) from the device connected to the AP 102. In S311, the CPU 201 determines whether or not the printer 101 is successfully detected. Specifically, the CPU 201 compares the identification information received in S310 with the identification information obtained from the printer 101 in S305, and determines whether or not coincident information is included. The CPU 201 proceeds to S312 in a case where the CPU 201 determines YES in S311. On the other hand, the CPU 201 proceeds to S313 in a case where the CPU 201 determines NO in S311.

In S312, the CPU 201 displays a setup success screen on the display unit 205. Thereafter, the processing of this flowchart is terminated. On the other hand, in S313, the CPU 201 displays a setup failure screen as error display. Thereafter, the processing of this flowchart is terminated.

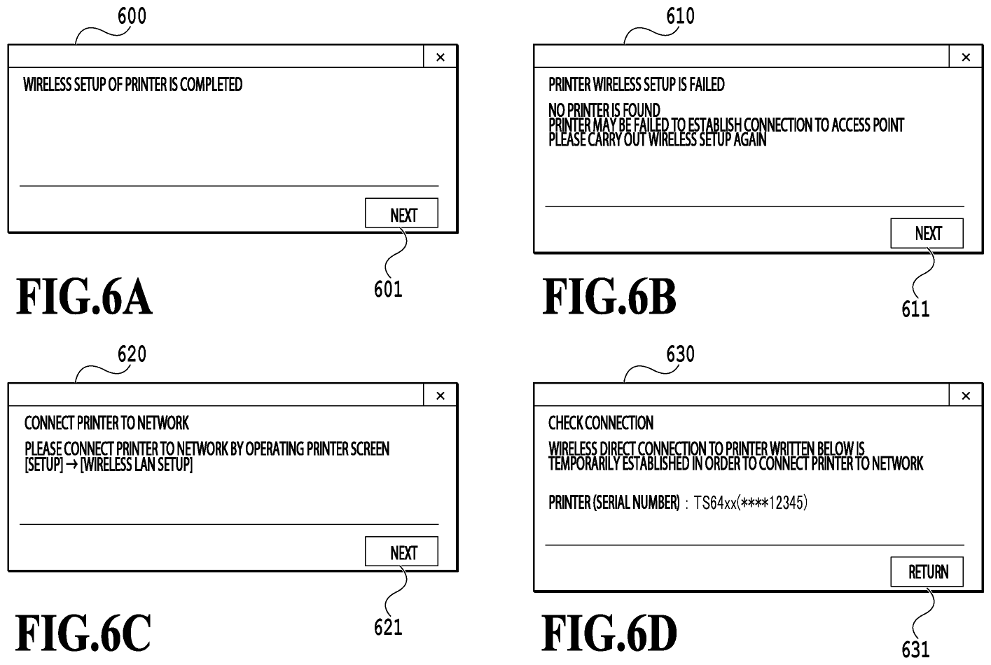

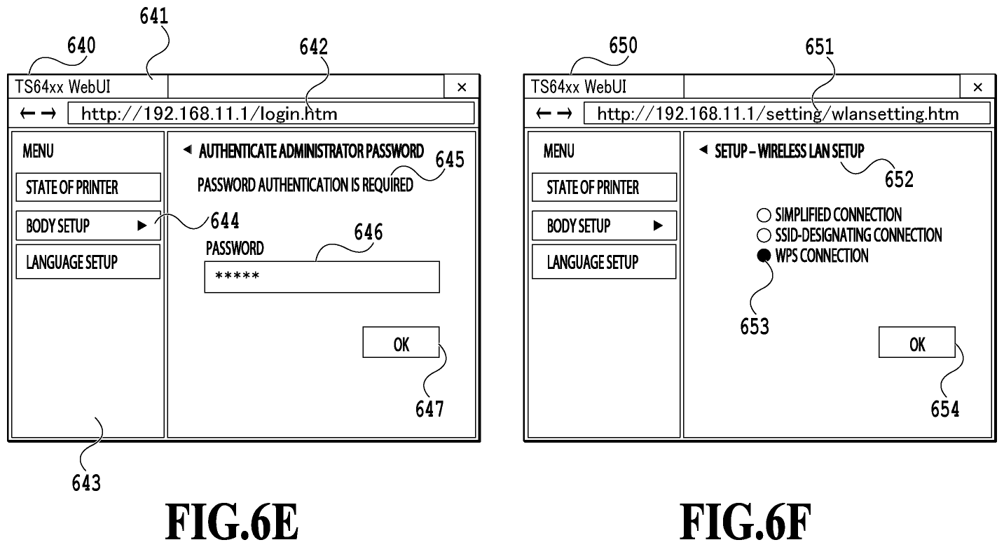

FIGS. 6A to 6F are diagrams showing setup screens to be displayed on the display unit 205 of the PC. FIG. 6A is a setup success screen 600 that indicates completion of setup of the printer in S312. In the case where the user presses a “next” button 601 on the setup success screen 600, the PC 100 terminates the wireless setup instruction processing (the processing to be carried out on the PC 100 side in the flowchart of FIG. 3). Here, the PC 100 may establish connection to the printer 101 at the timing of determination that the printer 101 is successfully detected in S311 or establish connection to the printer 101 at the timing of pressing the “next” button 601.

Meanwhile, FIG. 6B is a setup failure screen 610 that indicates the failure in setting up the printer in S313. The CPU 201 displays the setup failure screen 610 as shown in FIG. 6B in S313 in the case where the CPU 201 determines the failure in the wireless setup of the printer 101 in the processing in any of S303 or S311. The PC 100 terminates the wireless setup instruction processing (the processing to be carried out on the PC 100 side in the flowchart of FIG. 3) in the case where the user presses a “next” button 611 on the setup failure screen 610. The processing to be carried out on the PC 100 in FIG. 3 has been described above.

Subsequently, wireless setup processing of the printer 101 will be described. The wireless setup processing on the printer side is started in a case where the user carries out a prescribed instruction (operation) by using the display operating unit 237 of the printer 101.

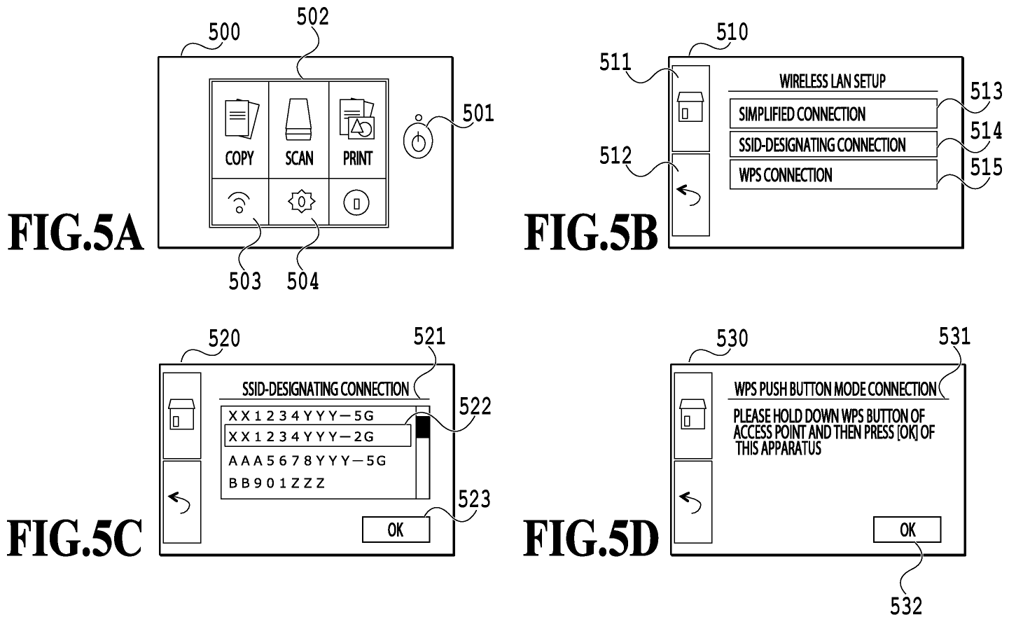

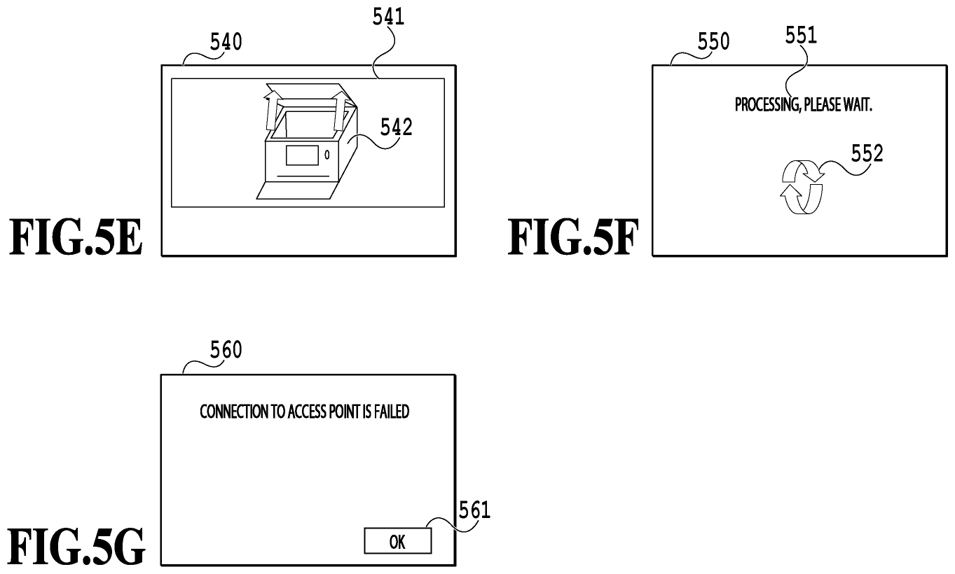

In S351, the CPU 231 provided to the printer 101 performs a search (passive scanning) for surrounding SSIDs, and creates an SSID list including the detected SSIDs. Next, in S352, the CPU 231 transitions to the wireless setup mode and completes preparation for the wireless direct connection for temporary connection. In this wireless setup mode, the printer 101 can operate the wireless LAN I/F 235 as the AP that beacons the temporary connection SSID. In the case where the processing from S302 to S304 is executed on the PC 100 side in this state, the printer 101 is enabled to start the P2P communication upon a connection request from the PC 100. Now, conditions for transitioning to the wireless setup mode will be described below with reference to FIGS. 5A to 5G.

FIGS. 5A to 5G show examples of display screens to be displayed on a printer operation panel 500 provided to the printer 101. FIG. 5A shows a state of displaying an initial screen 502 on the display operating unit 237 on the printer operation panel 500 of the printer 101. The initial screen 502 includes various function start buttons including “copy”, “scan”, and “print” buttons, a button 503 indicating a state of wireless operation, and a setup button 504. The printer operation panel 500 also includes a power button 501.

FIG. 5B shows a state of displaying a wireless LAN setup screen 510 on the display operating unit 237. The wireless LAN setup screen 510 is displayed by selecting “wireless LAN setup” on a setup menu (not shown) to be displayed by pressing the setup button 504 on the initial screen 502. A home button 511 is provided on the wireless LAN setup screen 510, and the display operating unit 237 returns to the initial screen 502 in the case where this button is pressed. The wireless LAN setup screen 510 is provided with a “return” button 512, and the display operating unit 237 returns to the setup menu (not shown) in the case where this button is pressed. The wireless LAN setup screen 510 is provided with respective options of “simplified connection 513”, “SSID-designating connection 514”, and “WPS connection 515”. These options can invoke various network connection setup functions. These various network connection setup functions will be described later.

Conditions to start an operation in the wireless setup mode are assumed to include a first condition and a second condition. The first condition is that “the communication apparatus 151 in a power-on state is subjected to a prescribed operation for network setup”. The second condition is that “the communication apparatus 151 is powered on by executing a power-on operation on the communication apparatus 151 in a state of not completing initial setup”. To be more precise, the first condition is that the “simplified connection 513” is pressed by the user. Meanwhile, to be more precise, the second condition is a case where the printer 101 is in a state of not being wirelessly connected at the time of the power-on by pressing the power button 501. Otherwise, the printer 101 may be configured to temporarily transition to the wireless setup mode temporarily in the case where the printer 101 is powered on for the first time after purchase (in a case where the power-on operation is executed for the first time by the user in a state of factory shipment (a state of arrival)) (at the start of the arrival mode), and the like. Here, the state of factory shipment corresponds to a state where the initial setup of the printer 101 is not completed, for example. For instance, the printer 101 is shipped from a factory in a state of not being equipped with ink tanks, a print head, and the like. Accordingly, the printer 101 carries out processing for making the printer 101 usable, which includes processing to urge the user to attach ink tanks, a print head, and the like included in the shipment, register adjustment, a cleaning treatment of the print heat, and so forth as the initial setup, for example. The state of factory shipment of the printer 101 is controlled by using a flag (an initial start flag) saved in the ROM 232, another memory, or the like. The printer 101 is configured to change a state of the initial start flag in response to completion of the initial setup so as not to activate the initial setup even in the case where the printer 101 is powered on after the completion of the initial setup. In order to use the printer 101, it is preferable to execute the network setup of the printer 101. Accordingly, in the present embodiment, the printer 101 starts the operation in the wireless setup mode at the time of the initial setup.

In S353, the CPU 231 determines whether or not there is the information obtaining request from the PC 100. The CPU 231 proceeds to S354 in the case where the CPU 231 determines YES in S353. On the other hand, the CPU 231 proceeds to S355 in the case where the CPU 231 determines NO in S353.

In S354, the CPU 231 carries out information transmission processing to the PC 100. As mentioned above, the information stated herein is the information including the SSID list detected as a consequence of the search for the surrounding APs by the printer 101, the MAC address of the wireless LAN I/F 235 included in the printer 101, and the like.

In S355, the CPU 231 determines whether or not the information indicating the wireless setup instruction is received from the PC 100. The CPU 231 returns to S353 in the case where the CPU 231 determines NO in S355. On the other hand, the CPU 231 proceeds to S356 in the case where the CPU 231 determines YES in S355.

In S356, the CPU 231 executes connection processing to the AP 102 designated by the PC 100. To be more precise, in S356, the CPU 231 executes the connection processing to the AP 102 by using the SSID and the password included in the wireless profile received from the PC 100. Then, in S357, the CPU 231 determines whether or not the connection processing between the printer 101 and the AP is successful. The CPU 231 terminates the processing of this flowchart in the case where the CPU 231 determines YES in S357. On the other hand, the CPU 231 proceeds to S359 in the case where the CPU 231 determines NO in S357.

In S359, the CPU 231 displays a setup failure screen 560 as shown in FIG. 5G on the display operating unit 237 of the printer 101. The CPU 231 terminates the processing of this flowchart in the case where the user presses an “OK” button 561 on the setup failure screen 560. The wireless setup processing to be carried out on the printer 101 side has been described above.

The transmission of the wireless profile of the AP 102, which has already been connected to the PC 100, to the printer 101 as described above makes it possible to connect the printer 101 to the AP 102 without requiring an input operation of the password and the like by using the printer 101.

Here, in the case where the printer 101 fails in establishing the connection to the AP 102 in S357 (in the case where the PC 100 fails in detection of the printer 101 in S311), the PC 100 and the printer 101 remain in a state of being not capable of communicating with each other. A conceivable factor of the failure of the printer 101 in establishing the connection to the AP 102 is insufficient quality of a radio wave between the printer 101 and the AP 102. In the meantime, another conceivable factor is an authentication method (such as WPA2 and WPA3) or a frequency band (such as 2.4 GHz and 5 GHz) adopted by the AP 102, which is not supported by the printer 101, for example. The printer 101 cannot establish the connection to the AP 102 in the case where the authentication method associated with the SSID 1 of the AP 102 is WPA3 Personal or in the case where the printer 101 does not support WPA3, for instance.

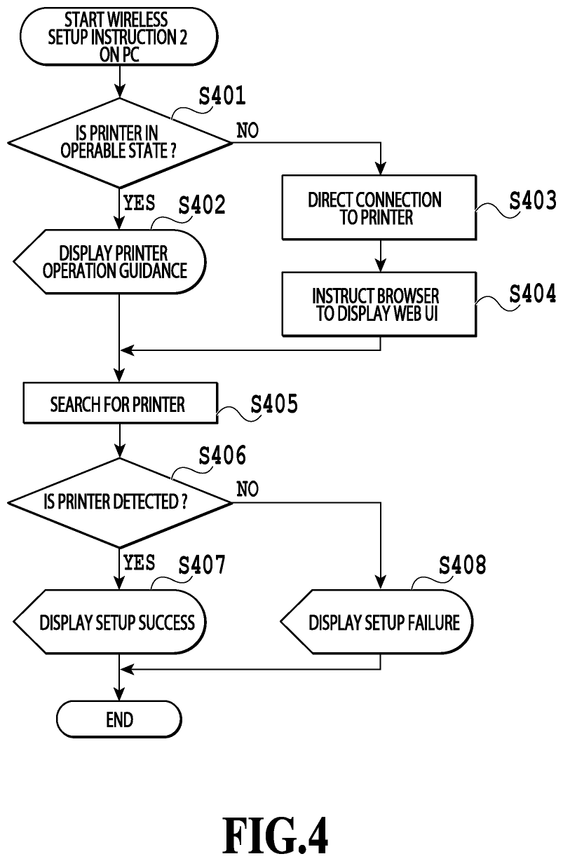

In the case where the PC 100 displays the setup failure screen 610 shown in FIG. 6B in S313 of FIG. 3, the PC 100 offers a different network setup unit to the user on the condition that the user presses the “next” button 611. Such a different network setup unit offered by the PC 100 will be described with reference to FIG. 4.

FIG. 4 is a flowchart showing an example of processing to instruct the wireless setup from the PC to the printer. The PC 100 starts wireless setup instruction processing 2 (processing of the flowchart shown in FIG. 4) in the case where the user presses the “next” button 611 on the setup failure screen 610 shown in FIG. 6B.

In S401, the CPU 201 of the PC 100 determines whether or not the printer 101 is in an operable state. To be more precise, operable state information is information as to whether or not the printer 101 includes the display operating unit 237 or information as to whether or not the display operating unit 237 is in the operable state. Meanwhile, there is also a printer which can execute a wireless setup function such as WPS by using a physical button (not shown) even though the printer 101 does not include the display operating unit 237. However, guidance on the display unit 205 of the PC 100 enables attentive guidance and therefore has better user convenience. Here, the PC 100 is assumed to obtain the operable state information on the printer 101 from the printer 101 in advance for the determination in S401. As for the timing of obtainment, the operable state information may be obtained at the timing to obtain the information from the printer 101 in S305 of FIG. 3. The CPU 201 proceeds to S402 in the case where the CPU 201 determines YES in S401. On the other hand, the CPU 201 proceeds to S403 in the case where the CPU 201 determines NO in S401.

In S402, the CPU 201 carries out printer operation guidance display. To be more precise, a network setup operation guidance screen 620 as shown in FIG. 6C is displayed on the display unit 205 of the PC 100. The network setup operation guidance screen 620 displays guidance to operate the setup button 504 of the display operating unit 237 of the printer 101, to invoke the wireless LAN setup screen 510, and to urge execution of the “SSID-designating connection 514” or the “WPS connection 515”.

In the case where the user selects the “SSID-designating connection 514” on the wireless LAN setup screen 510 of the printer shown in FIG. 5B, the printer 101 displays an SSID-designating connection screen 520 as shown in FIG. 5C on the display operating unit 237. The SSID-designating connection screen 520 displays an SSID list 521 which is obtained by the printer 101 by searching for the surrounding APs. Here, FIG. 5C shows a state 522 in which an SSID that reads “XX1234YYY-2G” on then SSID list 521 is selected. In the case where the user presses an “OK” button 523 in this state, the printer 101 displays a password input screen (not shown) necessary for establishing connection to “XX1234YYY-2G”. After the user inputs the password on the password input screen, the printer 101 executes the connection processing to “XX1234YYY-2G”.

On other hand, in the case where the user selects the “WPS connection 515”, the printer 101 displays a WPS push button mode connection screen (hereinafter referred to as a WPS screen) 530 as shown in FIG. 5D on the display operating unit 237. The WPS screen 530 displays a message 531 that urges to press a WPS button of the AP to which the user wishes to establish the connection. In a case where the user presses an OK button 532 on the WPS screen 530 of the printer 101 after pressing the WPS button of the AP to enable a WPS function of the AP, the printer 101 and the AP execute WPS connection processing.

After the printer 101 is connected to the AP 102 in accordance with the above-described two connection methods (the SSID-designating connection and the WPS push button mode connection), the PC 100 is in a state of being capable of detecting the printer 101 in the infrastructure connection through the AP 102. In a case where the user presses a “next” button 621 on the network setup operation guidance screen 620 displayed on the display unit 205 of the PC 100, the CPU 201 carries out detection processing of the printer 101 in the infrastructure connection through the AP 102 in S405.

Subsequently, in S406, the CPU 201 determines whether or not the printer 101 is successfully detected through the AP 102. The CPU 201 proceeds to S407 in the case where the CPU 201 determines YES in S406. On the other hand, the CPU 201 proceeds to S408 in the case where the CPU 201 determines NO in S406.

In S407, the CPU 201 displays the setup success screen 600 as shown in FIG. 6A on the display unit 205. The CPU 201 terminates the processing of this flowchart in the case where the user presses the “next” button 601 on the setup success screen 600.

In S408, the CPU 201 displays the setup failure screen 610 as shown in FIG. 6B on the display unit 205 as the error display. The CPU 201 terminates the processing of this flowchart in the case where the user presses the “next” button 611 on the setup failure screen 610.

Here, the wireless setup instruction 2 may be carried out again after the setup failure screen 610 is displayed in S408. Since there are various network connection units as shown in FIG. 5B, this arrangement has a meaning to provide an opportunity to carry out another unit which is yet to be executed or to provide an opportunity to carry out the same unit again.

Now, a description will be given of processing to be carried out in the case where the CPU 201 determines NO in S401. An example of an inoperable state of the printer means a case where the printer 101 is in the state of the arrival mode or a case where the printer 101 is in a state of executing certain processing such as the copy processing. In the case where the printer 101 is in the arrival mode, an arrival guidance screen 540 shown in FIG. 5E is displayed on the display operating unit 237 of the printer 101. Operation guidance to be provided to the user at the time of arrival is displayed in a guidance region 541 on the arrival guidance screen 540. Animated display 542 to demonstrate operation procedures for opening a cover of the printer 101 in order to attach a print head (not shown) or ink cartridges (not shown) to the printer 101 is shown in FIG. 5E. In a case where the above-mentioned operation guidance occupies the display operating unit 237, the printer 101 cannot display the wireless LAN setup screen 510 on the display operating unit 237. Meanwhile, in a case where the printer 101 is executing the copy processing, an in-progress screen 550 as shown in FIG. 5F is displayed on the display operating unit 237 of the printer 101. A message 551 for urging the user to wait some time for the operation or a progress ring 552 indicating the operation in progress is displayed on the in-progress screen 550. Since the in-progress screen 550 as mentioned above occupies the display operating unit 237, the printer 101 cannot display the wireless LAN setup screen 510 on the display operating unit 237.

Accordingly, in S403, the CPU 201 carries out direct connection processing to the printer 101. In this instance, the CPU 201 displays a connection check screen 630 as shown in FIG. 6D. The connection check screen 630 displays a message to notify the user of temporarily establishing direct connection to the printer 101 in order to carry out the network setup for the printer 101. Moreover, the connection check screen 630 displays “TS64xx” as a name of the printer 101 targeted for the temporary connection, and also displays a printer serial number “**** 12345” as identification information. In this way, the user can identify the printer 101 to be connected. The serial number of the printer 101 is assumed to be obtained at the timing of obtaining the printer information in S305.

Either direct connection for constant connection to be connected to the constant connection SSID or direct connection for temporary connection to be connected to the temporary connection SSID is acceptable to the direct connection 221 in S403. In the case of establishing connection to the constant connection SSID, the printer 101 is designed to stand by for connection by beaconing the constant connection SSID even in a case of failure in the connection processing (S356) to the AP. The PC 100 obtains constant connection SSID or the password targeted for connection in the processing to obtain the printer information (S305). In the case of establishing connection to the temporary connection SSID, an operation to execute the wireless setup mode of the printer 101 is required once again. Here, the user cannot display the wireless LAN setup screen 510 in the case where it is determined in S401 that the printer is in the inoperable state. In other words, the user cannot press the “simplified connection 513”. For this reason, in the case of instructing the printer 101 to perform the wireless setup (S307), the PC 100 may also issue an instruction to transition to the wireless setup mode once again in the case of failure in the connection processing (in the case of determining NO in S357). Alternatively, the printer 101 may voluntarily return to the wireless setup mode once again in the case of failure in the connection processing (in the case of determining NO in S357).

After the direct connection to the printer 101 is established in S403, the CPU 201 instructs a web browser application (hereinafter referred to as a browser) to display a web UI screen of the printer 101 in S404. The browser is one of the programs 203 stored in the ROM 202 of the PC 100, which is software to download web resources (HTML/CSS/Javascript and the like) retained by a web server to the PC 100 and to display the web resources thereon. Meanwhile, a web UI is designed to cause the printer 101 to operate as a web server so as to provide the web resources retained by the printer 101 to a web client such as the PC 100.

FIG. 6E is a web UI screen to be displayed on the display unit 205 of the PC 100. A character string that reads “TS64xx WebUI” is displayed as the name of the printer 101 on a tab 641 of a browser 640. An address of a web resource of the printer 101 that operates as the web server is displayed in an address bar 642 of the browser. A menu 643 is arranged in a left pane of the web UI of the printer 101. FIG. 6E shows a state in which “body setup 644” is selected. Although the “body setup 644” is selected herein, the address displayed in the address bar 642 reads “http://192.168.11.1/login.html”, and FIG. 6E displays an administrator log-in page 645. Only an administrator of the printer 101 can change or refer to the body setup 644 of the web UI, and an administrator log-in operation is required in the case where the body setup 644 is selected. The administrator log-in page 645 includes a password input field 646. In the case where the user inputs the password and presses an “OK” button 647, the web UI opens a body setup page (not shown).

In the case where it is cumbersome to input the administrator log-in password on the web UI, the software to execute the flowchart of the wireless setup instruction 2 shown in FIG. 4 may recognize a password at the time of initial shipment in advance. In this way, it is possible to configure to finish the authentication in advance based on the premise that the printer 101 is in the state of the arrival mode (working on initial installation). To be more precise, in the case of instructing the browser to display the web UI in S404, a password token is attached as a query parameter to URL of the web UI that requests to the browser, and the printer 101 that receives the password token skips the administrator authentication. The PC 100 obtains the password token from the printer 101 in advance by transmission and reception of web API. The timing to obtain the password token may take place in S403 or in S305. In this case, the URL to be opened in S404 has a configuration of “http://192.168.11.1/setting/wlansetting.html?token=xxxxxx”. A parameter following a mark “/” is called the query parameter, in which information “xxxxxx” is attached to a key that reads “token”. Here, the information “xxxxxx” represents the password token. A character string “setting/wlansetting.html” is designated as the URL. A screen to be opened on the browser by the instruction in S404 is a wireless LAN setup page of FIG. 6F.

In the case where the user presses a wireless LAN setup button included in the body setup page (not shown), a browser 650 opens a wireless LAN setup page 652 of the web UI as shown in FIG. 6F. In this instance, a character string “http://192.168.11.1/setting/wlansetting.html” is displayed in an address bar 651 of the browser 650. The wireless LAN setup page 652 displays various network connection functions held by the printer 101, and FIG. 6F shows a state in which “WPS connection 653” is selected. In the case where an “OK” button 654 is pressed in the state where the “WPS connection 653” is selected, the printer 101 executes the WPS connection processing. In the case of instructing the printer 101 about the various network connection functions on the web UI screen of FIG. 6F, the printer 101 establishes the connection to the AP 102.

After instructing the browser to display the web UI in S404, the CPU 201 carries out the detection processing of the printer 101 in the infrastructure connection through the AP 102 in S405. Subsequent procedures S406 to S408 are the same as those described above. Thereafter, the CPU 201 terminates the processing of this flowchart.

As described above, according to the present embodiment, it is possible to set up the wireless connection more easily. To be more precise, even in a case where a simplified network connection unit is failed, it is still possible to offer a network connection setup unit of the printer 101 by displaying the web UI screen of the printer 101 on the browser of the PC 100. Moreover, according to the present embodiment, it is possible to instruct the printer 101 to set up the network connection by operating the PC 100. Accordingly, the user can execute the network connection setup even in the state where the display operating unit 237 of the printer 101 is occupied. Furthermore, the network connection setup unit offered by the web UI of the printer 101 can provide not only the WPS connection exemplified in the description of the present embodiment but also a network connection unit owned by a different printer 101. There are various different network connection units including the SSID-designating connection to cause the user to designate the SSID list detected by the printer 101, Wi-Fi Easy Connect (trademark), IEEE 802.1x/EAP authentication, and the like. The PC 100 does not have to be aware in advance as to which one of the various network connection units that are present is to be loaded on the printer 101 as long as the PC 100 displays the relevant unit on the web UI of the printer 101. This makes it easier to design and maintain the software that carries out the wireless setup instruction 2.

### Other Embodiments

The embodiment has described the configuration in which the direct connection 221 in S403 uses the wireless LAN I/F (207 or 235). Instead, in a case where both the PC 100 and the printer 101 are provided with a wired LAN I/F or a USB I/F, the PC 100 and the printer 101 may establish the P2P connection by using these interfaces.

Meanwhile, the embodiment has described the configuration to carry out the processing to display the web UI by using the browser in S404. Instead, a graphical user interface (GUI) of the software that carries out the wireless setup instruction 2 may perform web view display.

The above-describe embodiment can also be realized by executing processing to be described below. Specifically, the software (a program) to implement the functions of the above-described embodiment is supplied to a system or an apparatus through a network or various storage media, and a computer (such as a CPU or an MPU) of the system or the apparatus reads the program and executes the processing. Meanwhile, the program may be executed by a single computer or executed by two or more computers in conjunction with each other. In the meantime, it is not always necessary to implement all of the above-described processing by way of software. Instead, all or part of the processing may be implemented by hardware such as an ASIC. Likewise, regarding the CPU, the single CPU does not always have to carry out all of the processing. Instead, two or more CPUs may carry out the processing in conjunction with each other.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-188295, filed Nov. 25, 2022, which is hereby incorporated by reference wherein in its entirety.

What is claimed is:

1. An information processing apparatus comprising at least one memory and at least one processor and/or at least one circuit which function as:
a first setup unit configured to execute first wireless setup in order to establish connection between a communication apparatus and an access point; and
a display unit configured to display information for establishing the connection between the communication apparatus and the access point on a display unit of the information processing apparatus in a case where the connection between the communication apparatus and the access point is not established by the first setup unit.

2. The information processing apparatus according to claim 1, wherein
the display unit displays information on the display unit provided to the information processing apparatus based on a situation in which a display unit of the communication apparatus is usable, the information urging processing for establishing the connection between the communication apparatus and the access point at the display unit of the communication apparatus.

3. The information processing apparatus according to claim 2, wherein
the information for establishing the connection of the access point is information urging processing for executing the processing for establishing the connection between the communication apparatus and the access point by operating the display unit of the communication apparatus.

4. The information processing apparatus according to claim 1, wherein
in the case where the connection between the communication apparatus and the access point is not established by the first setup unit, the display unit displays information for executing second wireless setup for establishing the connection between the communication apparatus and the access point on the display unit of the information processing apparatus based on a situation in which the communication apparatus is not provided with a display unit or a case in which the display unit of the communication apparatus is not usable.

5. The information processing apparatus according to claim 1, further comprising:
a second setup unit for establishing the connection between the communication apparatus and the access point based on a situation in which the communication apparatus is not provided with a display unit or a case in which the display unit of the communication apparatus is not usable in the case where the connection between the communication apparatus and the access point is not established by the first setup unit.

6. The information processing apparatus according to claim 4, wherein
the case in which the display unit is not usable is any of a state in which the communication apparatus is working on initial installation and a state in which the communication apparatus is executing specific processing.

7. The information processing apparatus according to claim 1, wherein
the first setup unit establishes the connection between the communication apparatus and the access point by establishing temporary connection to the communication apparatus by using a temporary connection SSID of the communication apparatus and transmitting connection information on the access point.

8. The information processing apparatus according to claim 5, wherein
the second setup unit executes second wireless setup for establishing the connection between the communication apparatus and the access point by establishing direct connection between the information processing apparatus and the communication apparatus.

9. The information processing apparatus according to claim 8, wherein
the second setup unit displays web UI of the communication apparatus on the display unit of the information processing apparatus by the direct connection, and executes the second wireless setup through an operation of the web UI.

10. The information processing apparatus according to claim 8, wherein
the direct connection is a state of connection between the information processing apparatus and the communication apparatus by any of wireless connection using a constant connection SSID or a temporary connection SSID of the communication apparatus, connection through wired LAN, and connection through USB.

11. The information processing apparatus according to claim 10, wherein
the information processing apparatus uses the constant connection SSID and a password obtained in advance by the first setup unit in a case of establishing the wireless connection to the constant connection SSID in the direct connection.

12. The information processing apparatus according to claim 8, wherein
the first setup unit transmits information to the communication apparatus, the information indicating an instruction to transition to a state of network setup in which the communication apparatus behaves as an access point corresponding to a temporary connection SSID in the case where the connection between the communication apparatus and the access point is not established, and
in a case of establishing wireless connection to the temporary connection SSID by the direct connection, the second setup unit searches for the temporary connection SSID of the communication apparatus and establishes temporary connection to the communication apparatus.

13. The information processing apparatus according to claim 1, wherein
the case where the connection between the communication apparatus and the access point is not established by the first setup unit is a case where any of an authentication method and a frequency band of the access point is not supported by the communication apparatus.

14. A non-transitory computer readable storage medium storing a program which functions in an information processing apparatus and causes the information processing apparatus to function as:
a first setup unit configured to execute first wireless setup in order to establish connection between a communication apparatus and an access point; and
a display unit configured to display information for establishing the connection between the communication apparatus and the access point on a display unit of the information processing apparatus in a case where the connection between the communication apparatus and the access point is not established by the first setup unit.

15. A method of controlling an information processing apparatus, comprising:
a first setup step of executing first wireless setup in order to establish connection between a communication apparatus and an access point; and
a display step of displaying information for establishing the connection between the communication apparatus and the access point on a display unit of an information processing apparatus in a case where the connection between the communication apparatus and the access point is not established in the first setup step.
